(19) United States
(12) Patent Application Publication
(10) Pub. No.: US 2026/0287932 A1
(43) Pub. Date: Sep. 24, 2026

(54) METHOD AND APPARATUS OF CONTROLLING FOCUS-ADJUSTABLE GLASSES BASED ON USER FEEDBACK

(71) Applicant: Electronics and Telecommunications Research Institute, Daejeon (KR)

(72) Inventors: Young Mi Song, Daejeon (KR); Moo Seop Kim, Daejeon (KR); Sungjun WANG, Daejeon (KR); Chi Yoon Jeong, Daejeon (KR); SuGil Choi, Daejeon (KR)

(21) Appl. No.: 19/370,542

(22) Filed: Oct. 27, 2025

(30) Foreign Application Priority Data
Mar. 18, 2025 (KR) 10-2025-0034837

(51) Int. Cl. G02C 7/08; G06F 3/01

(52) U.S. Cl. CPC G02C 7/085; G06F 3/013

(57) ABSTRACT

A method of controlling focus-adjustable glasses based on user feedback is provided. The method includes a step of classifying a feedback type of user feedback data collected from focus-adjustable glasses by using a feedback classifier, a step of determining a focus adjustment policy according to the classified feedback type and performing a focus adjustment operation corresponding to the determined focus adjustment policy by using a focus controller, a step of collecting after-focus-adjustment user feedback data from the focus-adjustable glasses adjusted based on the focus adjustment operation and updating a compensation function on the focus adjustment operation by using a feedback learner, based on the after-focus-adjustment user feedback data, and a step of maximizing the updated compensation function to learn the focus adjustment policy by using the focus controller.

### CROSS-REFERENCE TO RELATED APPLICATIONS

This application claims the benefit of the Korean Patent Application No. 10-2025-0034837 filed on Mar. 18, 2025, which is hereby incorporated by reference as if fully set forth herein.

### BACKGROUND

### Field of the Invention

The present disclosure relates to a method and apparatus of controlling focus-adjustable glasses based on user feedback, and more particularly, to a method and apparatus of controlling focus-adjustable glasses based on user feedback, which may increase the accuracy of focus and the easiness of focus adjustment, based on user feedback, and may continuously learn the user feedback to provide an optimal user-customized focus.

### Discussion of the Related Art

Conventional focus-adjustable glasses provides a function which tracks an eye-gaze of a user to automatically adjust a focus of a focus-adjustable lens, based on the eye-gaze. In this case, it is important to accurately predict an eye-gaze of a user, but conventional eye-gaze analysis technology based on sensor has a limitation in accuracy due to indirectly inferring an eye-gaze.

Moreover, conventional focus-adjustable glasses adjust a focal distance, based on that an eye-gaze of a user is intactly maintained, but because a real focus is adjusted by a crystalline lens of a user, there is a problem of user adaptation. Particularly, a focus of a user is not solved through simple single adjustment, and various focus adjustments are needed based on various variables. For example, the needs for a focus of a user may be frequently changed based on an environment change such as day and night, an action change such as driving, reading, and computer work, an eye state change such as the fatigue of eyes, and a vision change caused by aging.

However, current technologies use only eye-gaze information about a user and do not sufficiently consider a state or environment change of a user. Therefore, in order to provide a more natural and accurate visual experience, it is required to develop various component technologies. However, research on a method which implements a natural and precise visual experience through an interaction with a user among important points is still insufficient.

### SUMMARY

An aspect of the present disclosure is directed to providing a method and an apparatus, which may effectively reflect user feedback to control focuses of focus-adjustable glasses so as to be suitable for an intention of the user.

To achieve these and other advantages and in accordance with the purpose of the invention, as embodied and broadly described herein, there is provided a method of controlling focus-adjustable glasses based on user feedback, the method including: a step of classifying a feedback type of user feedback data collected from focus-adjustable glasses by using a feedback classifier; a step of determining a focus adjustment policy according to the classified feedback type and performing a focus adjustment operation corresponding to the determined focus adjustment policy by using a focus controller; a step of collecting after-focus-adjustment user feedback data from the focus-adjustable glasses adjusted based on the focus adjustment operation and updating a compensation function on the focus adjustment operation by using a feedback learner, based on the after-focus-adjustment user feedback data; and a step of maximizing the updated compensation function to learn the focus adjustment policy by using the focus controller.

In another aspect of the present invention, there is provided a control apparatus for controlling focus-adjustable glasses based on user feedback, the control apparatus including: a communication device configured to receive user feedback data from focus-adjustable glasses; and a processor configured to learn the user feedback data to execute a software module performing focus adjustment of the focus-adjustable glasses, wherein the software module includes: a feedback classifier configured to classify a feedback type of user feedback data collected from the focus-adjustable glasses; a focus controller configured to determine a focus adjustment policy according to the classified feedback type and perform a focus adjustment operation corresponding to the determined focus adjustment policy; and a feedback learner configured to collect after-focus-adjustment user feedback data from the focus-adjustable glasses adjusted based on the focus adjustment operation and update a compensation function on the focus adjustment operation, based on the after-focus-adjustment user feedback data.

The present disclosure may provide technology which may analyze a user focus request, based on explicit and implicit feedback, and thus, may perform immediate focus adjustment and may determine a user focus pattern through continuous learning to provide a person-customized focus. Accordingly, the present disclosure may adjust a focus in real time through an interaction with a user, and moreover, unlike conventional technology, may learn user feedback to continuously provide an optimized focus, in addition to simply reflecting feedback.

Moreover, the present disclosure may learn a user preference pattern over time, and thus, may predict a preference of the user and may provide an optimized focus even without a personal feedback input in all situations. Accordingly, a personal request of the user for focus adjustment may decrease, and the user may be provided with an optimal focus to be adaptive for an environment condition and a personal state in various situations such as reading, driving, and computer manipulation.

As a result, the present disclosure may maximize a user experience and may enable personalized focus adjustment, thereby providing an optimal focus environment and the convenience of a user enhanced compared to conventional technology.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram for describing an apparatus for implementing a method of controlling focus-adjustable glasses based on user feedback according to an embodiment of the present disclosure.

FIG. 2 is a configuration diagram of a software module needed for performing a method of controlling focus-adjustable glasses based on user feedback according to an embodiment of the present disclosure.

FIG. 3 is a flowchart for describing a method of controlling focus-adjustable glasses based on user feedback according to an embodiment of the present disclosure.

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

In the following description, the technical terms are used only for explaining a specific embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

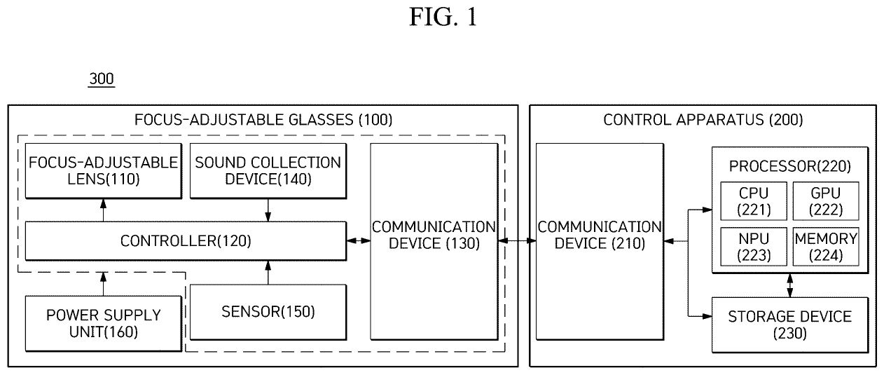

FIG. 1 is a block diagram for describing an apparatus 300 for implementing a method of controlling focus-adjustable glasses based on user feedback according to an embodiment of the present disclosure.

Referring to FIG. 1, the apparatus 300 for implementing a method of controlling focus-adjustable glasses based on user feedback according to an embodiment of the present disclosure may include focus-adjustable glasses 100 and a control apparatus 200.

The focus-adjustable glasses 100 may communicate with the control apparatus 200 through a wired and/or wireless communication scheme. Here, wired communication may include, for example, a universal serial bus (USB), an inter-integrated circuit (I2C), a serial peripheral interface (SPI), a universal asynchronous receiver-transmitter (UART), a high-definition multimedia interface (HDMI), and power over Ethernet (POE). Wireless communication may include, for example, Bluetooth, Wi-Fi, near field communication (NFC), Zigbee or Z-Wave, and ultra-wideband (UWB).

The focus-adjustable glasses 100 may be configured to receive focus adjustment data from the control apparatus 200, based on the wired and/or wireless communication scheme. The focus-adjustable glasses 100 may be configured to automatically adjust a focus of a focus-adjustable lens described below, based on focus adjustment data received from the control apparatus 200.

To this end, the focus-adjustable glasses 100 may include a focus-adjustable lens 110, a controller 120, a communication device 130, a sound collection device 140, a sensor 150, and a power supply unit 160.

The focus-adjustable lens 110 may be implemented with, for example, a liquid lens, a deformable lens, or an electrowetting lens. The liquid lens may be a lens operating based on a method which adjusts a liquid refractive index to adjust a focus, based on control by the controller 120. The deformable lens may be, for example, a lens operating based on a method which adjusts a curvature of a lens by using an electrical or mechanical force, based on control by the controller 120. The electrowetting lens may be, for example, a lens operating based on a method which moves a liquid-liquid boundary to adjust a focus by using an electric field, based on control by the controller 120.

The controller 120 may be an element which controls and manages an overall operation of each of peripheral elements 110, 130, 140, 150, and 160. The controller 120 may be implemented as, for example, a small chip equipped with a microprocessor. The controller 120, for example, may control a liquid refractive index, an electrical or mechanical force, and an electric field of the focus-adjustable lens 110 according to focus adjustment data received from the control apparatus 200, in order to adjust a focus of the focus-adjustable lens 110.

Moreover, the controller 120 may collect user feedback data and may transmit the collected user feedback data to the control apparatus 200 through the communication device 130. The communication device 130 may be configured to include various communication components to support wired and/or wireless communication between the focus-adjustable glasses 100 and the control apparatus 200.

The user feedback data may include, for example, explicit feedback data and implicit feedback data. The user feedback data may be referred to as multimodal data.

The explicit feedback data may include, for example, a voice command data of a user. The voice command data, for example, may be data including a voice command such as “adjust more sharply” or “adjust to conveniently read”. The voice command data may be provided from the sound collection device 140. The sound collection device 140 may be, for example, a subminiature microphone attached to a specific position of a glasses frame forming a structure of the focus-adjustable glasses 100.

The implicit feedback data may include, for example, biometric motion data. The biometric motion data may be, for example, data associated with an eye motion pattern. The eye motion pattern may include, for example, data obtained by digitizing eye motions such as ‘the number of blinks’, ‘eyes narrowing (an area of eyelid)’, ‘pupil dilation’, and ‘eye frowning’. The eye motion data may include, for example, eye tracking data or gaze tracking data.

The eye motion data may be provided from the sensor 150. The sensor 150 may include, for example, an infrared (IR) camera sensor which irradiates IR light onto eyes and receives reflected light to track a position of a pupil and motions of eyes, an electrooculography (EOG) sensor which senses an electrical signal generated based on motions of eyes by using an electrode attached to a periphery of eyes, an optical flow sensor which tracks motions of eyes through a change in an image pattern, and a high-precision small camera which tracks fine motions of eyes and tracks eyes at a high speed to determine an accurate gaze direction.

The power supply unit 160 may perform a function of supplying a working power to the peripheral elements 110 to 150.

The control apparatus 200 may receive user feedback data including the explicit feedback data and the implicit feedback data from the focus-adjustable glasses 100. Here, the user feedback data may be feedback data of a focus initially set in the focus-adjustable glasses 100. Also, the user feedback data may be data which is collected and published by a public organization, a government, or an enterprise and may further include open data which is published to be used by everybody.

The control apparatus 200 may continuously learn the received user feedback data to generate user-customized focus adjustment data for allowing focuses of the focus-adjustable glasses 100 to be naturally and accurately controlled in a change in a user state representing a peripheral environment (for example, illumination, etc.) and an action (for example, driving, reading, etc.) of the user and may provide the user-customized focus adjustment data to the focus-adjustable lens 110.

To this end, the control apparatus 200 may be a computing device which is configured to include a communication device 210, a processor 220, and a storage device 230. The computing device may be implemented as, for example, a smartphone, a desktop computer, or a server-class computer.

The computing device 210 may be configured to include various communication components to support wired and/or wireless communication between the focus-adjustable glasses 100 and the control apparatus 200.

The processor 220 may continuously learn the user feedback data provided from the focus-adjustable glasses 100 or open user feedback data provided from an external server to execute an artificial intelligence (AI) model which generates user-customized focus adjustment data. Here, the AI model may include a hierarchical reinforcement learning model which performs multi-level decision through a hierarchically divided policy. To execute the AI model, the processor 220 may include a central processing unit (CPU) 221 which performs a general-purpose operation, a graphics processing unit (GPU) 222 which performs a large-scale parallel operation, and a neural processing unit (NPU) 223 which accelerates an artificial neural network operation. Additionally, the processor 220 may further include a memory 224 which supports high-speed data processing of the CPU 221, the GPU 222, and the NPU 223, and the memory 224 may be coupled to the CPU 221, the GPU 222, and the NPU 223 to enable the efficient learning and inference of the hierarchical reinforcement learning model. The CPU 221, the GPU 222, the NPU 223, and the memory 224 may be integrated into a single chip architecture, and thus, a high-performance operation and optimized data processing may be efficiently performed in one package. Such an integrated design may minimize data transfer delay between operational devices and may maximize power efficiency to enhance the real-tile execution and learning performance of the hierarchical reinforcement learning model.

The storage device 230 may include non-volatile and volatile memories of various types so as to support the execution and learning of the hierarchical reinforcement learning model. Therefore, the storage device 230 may efficiently store and manage a process code needed for a weight, learning data, an intermediate operation result, and a system operation of a model. In detail, in a case which needs high-speed data access, the storage device 230 be configured to include a volatile memory such as dynamic random access memory (DRAM) and a non-volatile memory (NVM) or a solid state drive (SSD) based non NAND flash so as to store massive data.

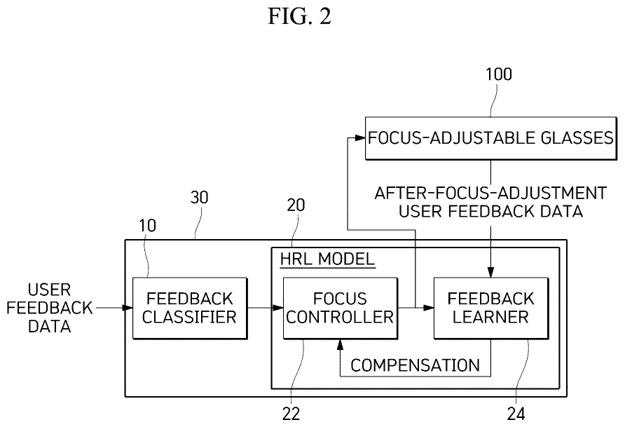

FIG. 2 is a configuration diagram of a software module needed for performing a method of controlling focus-adjustable glasses based on user feedback according to an embodiment of the present disclosure.

Referring to FIG. 2, a software module 30 according to an embodiment of the present disclosure may be executed by the processor 220 of FIG. 1. The software model 30 may include, for example, a feedback classifier 10 and a hierarchical reinforcement learning (HRL) model 20 so as to perform a method of controlling focus-adjustable glasses based on user feedback. The HRL model 20 may include, for example, a focus controller 22 and a feedback learner 24.

The feedback classifier 10 may collect the user feedback data including the explicit feedback data and the implicit feedback data and may classify a focus adjustment type based on the user feedback data.

The focus controller 22 of the HRL model 20 may perform hierarchical reinforcement learning to determine a policy, based on the hierarchical adjustment type classified by the feedback classifier 10, and may generate focus adjustment data to perform the focus adjustment of the focus-adjustable glasses 100 (or a focus-adjustable lens (110 of FIG. 1)), based on the determined policy.

The feedback learner 24 of the HRL model 20 may collect after-focus-adjustment user feedback data from the focus-adjustable glasses 100, in order to monitor whether the focus adjustment of the focus-adjustable glasses 100 is additionally needed.

The feedback learner 24 may continuously learn the after-focus-adjustment user feedback data to user's focus preference and may optimize the focus adjustment of the focus controller 22, based on the predicted user's focus preference. Here, for example, based on continuously learning the after-focus-adjustment user feedback data, the feedback learner 24 may learn a reinforcement learning model by using a deep Q-network (DQN).

### Feedback Classifier 10

The feedback classifier 10 may analyze a user request, based on the user feedback data including the explicit feedback data and the implicit feedback data, and may classify a feedback type (hereinafter referred to as a ‘focus adjustment type(s)’), based on a result of the classification. Here, the focus adjustment type(s) may include, for example, sharpness adjustment, focus adjustment for environment adaptation, short-distance focus adjustment, and long-distance focus adjustment.

The feedback classifier 10 may analyze the explicit feedback data including a voice command such as “more sharply” or “adjust to conveniently read” through the sound collection device (for example, a microphone or the like) of the focus-adjustable glasses 100 by using a voice recognition algorithm and/or a natural language processing (NLP) algorithm and may thus classify focus adjustment type(s).

The feedback classifier 10 may analyze the implicit feedback data representing a user stress or user discomfort such as the degree of eyes narrowing, the degree of blinking, the degree of pupil dilation, and the degree of eye frowning, based on the sensor 150 of the focus-adjustable glasses 150. Here, the implicit feedback data may be nonverbal behavior data associated with an eye motion unlike the explicit feedback data.

The feedback classifier 10 may analyze the user feedback data as an explicit request of a user such as a voice command and an implicit request for adjusting in detail a comfort setting. Here, the implicit request may be used as an auxiliary clue.

The explicit feedback data which is the explicit request may clearly represent a request of the user, and thus, may be preferentially used to optimize focus adjustment. The implicit feedback data which is the implicit request may be used to additionally optimize focus adjustment after focus adjustment is optimized based on the explicit feedback data, or the explicit feedback data is not provided. That is, the implicit feedback data may be selectively used in a process of optimizing focus adjustment. Such feedback classification may be for allowing feedback processing to be efficient and to be performed on a user.

The feedback classifier 10 may classify a text with keywords to determine a feedback type (for example, focus adjustment) desired by the user, based on voice recognition on the explicit feedback data including a voice command. For example, when the user utters “more sharply”, the feedback classifier 10 may classify the utterance into a sharpness adjustment request, and when the user utters “adjust to conveniently read book”, the feedback classifier 10 may classify the utterance into a short-distance focus request.

The feedback classifier 10 may be implemented as various AI models. For example, the feedback classifier 10 may include an input layer, a feature extraction layer, a classification model, and an output layer. The user feedback data including the explicit feedback data and the implicit feedback data may be input to the input layer. The feature extraction layer may extract a feature vector in the explicit feedback data and the implicit feedback data. For example, the feature extraction layer may extract a keyword in the explicit feedback data including the voice command and may extract an eye motion pattern in the implicit feedback data. The classification model may classify a focus adjustment type, based on the feature vector. The output layer may output a focus adjustment type(s) classified by the classification model.

### Focus Controller 22

The focus controller 22 may determine a focus adjustment policy (hereinafter referred to as a ‘policy’), based on the focus adjustment type(s) classified by the feedback classifier 10, and may determine focus adjustment according to the determined policy. The focus controller 22 may generate focus adjustment data corresponding to the determined focus adjustment and may provide the focus adjustment data to the focus-adjustable glasses 100.

The focus controller 22 may determine the policy through hierarchical reinforcement learning. The policy may include a high-level policy and a low-level policy. Here, the high-level policy may denote a policy which determines a preference of the focus adjustment type(s) classified by the feedback classifier 10. The low-level policy may denote a policy which selects a focus adjustment operation corresponding to the determined focus adjustment type(s) according to the preference.

The explicit feedback data including the voice command may be an explicit request of the user and may be feedback in which an intention of the user is directly reflected. Therefore, a focus adjustment type classified based on the explicit feedback data according to the high-level policy may be determined to be a prior processing target. The implicit feedback data associated with an eye motion may be feedback representing the degree of discomfort on a current focus setting. Accordingly, a focus adjustment type classified based on the implicit feedback data according to the high-level policy may be determined to be a next processing target. Also, the high-level policy may be based on an environment such as a user action (for example, reading and driving) and an illumination condition. The high-level policy may be used as information for determining a low-level policy which is to be activated.

The high-level policy may select a low-level policy which is the most suitable for focus adjustment. Examples of a low-level policy suitable for focus adjustment may be as follows.

(1) Sharpness adjustment policy: executed when it is needed to improve the sharpness or clearness of a focus through a voice command such as “more sharply”.

(2) Environment adaptation policy: executed when explicit feedback such as an eye motion pattern where eyes narrow in dark illumination is sensed, and focus adjustment on brightness is needed

(3) Short-distance focus policy: executed in a situation where short-distance focus adjustment is needed like a reading action

(4) Long-distance focus policy: executed in a situation where long-distance focus adjustment is needed like a driving action

The high-level policy may determine a low-level policy which is to be activated for focus adjustment, based on a focus adjustment type(s) to which a preference is assigned. For example, when the sharpness adjustment policy is activated on voice feedback “more sharply”, and eye motion feedback where eyes narrow due to dark is sensed, the environment adaptation policy may be activated.

Based on a high-level policy on the preference designation of the focus adjustment type(s) and the determination of an activated low-level policy, user feedback may be efficiently processed according to importance, and quick and effective focus adjustment may be performed through an interaction with a user.

When an appropriate low-level policy is selected, the focus controller 22 may calculate a parameter for focus adjustment according to the selected low-level policy. In each policy, a predefined parameter guiding the degree of adjustment on each of focus, sharpness, and brightness may be defined based on feedback. That is, a current focus setting state, a distance, an illumination condition, and a user action may be evaluated, and a policy may be set based on a focus adjustment type desired by a user.

The focus controller 22 may determine sharpness (focus adjustment data) according to the degree to which a current focus is dim and may optimize focus adjustment data for reducing the fatigue of eyes according to the degree to which illumination is dark. Also, the focus controller 22 may adjust a focus distance (focus adjustment data) needed for adjusting a short-distance or long-distance focus to increase sharpness.

### Feedback Learner 24

The feedback learner 24 may evaluate whether focus adjustment succeeds, based on user satisfaction, and may update a compensation function associated with a performed focus adjustment operation to improve a focus adjustment performance of the focus controller 22. That is, the feedback learner 24 may learn after-focus-adjustment user feedback data to continuously improve a response to a similar situation later, and thus, may enable user-customized focus adjustment. Herein, the compensation function may be referred to as a Q-value. The Q-value may be the term denoting an estimation value of long-term compensation which is expected when performing a specific action in a specific state and may be repeatedly updated through a reinforcement learning algorithm, and the focus controller 22 may be used as a criterion which selects an optimal action.

The feedback learner 24 may perform focus adjustment, and then, may collect additional user feedback data for checking whether the focus adjustment succeeds. That is, the feedback learner 24 may collect after-focus-adjustment user feedback data.

When after-focus-adjustment explicit feedback data including a voice command such as “good” is collected as the after-focus-adjustment user feedback data, the feedback learner 24 may recognize the explicit feedback data as positive feedback.

Moreover, when explicit feedback data is not provided, in a case which collects after-focus-adjustment implicit feedback data such as a reduction in the number of blinks or the relief of eye strain, the feedback learner 24 may recognize the explicit feedback data as positive feedback representing the visual comfort of a user. Here, for example, a reduction in the number of blinks may be checked by comparing the number of before-focus-adjustment blinks with the number of after-focus-adjustment blinks. The relief of eye strain, for example, may be checked by comparing an area of a before-focus-adjustment eyelid with an area of an after-focus-adjustment eyelid. When the area of the after-focus-adjustment eyelid is greater than the area of the before-focus-adjustment eyelid, the relief of eye strain may be recognized.

Moreover, when after-focus-adjustment explicit feedback data including a voice command such as “still dim” or “more sharply” is collected, the feedback learner 24 may recognize the explicit feedback data as negative feedback. This may denote that additional focus adjustment is needed. When the feedback learner 24 recognizes the negative feedback, the feedback learner 24 may train the focus controller 22 to again select (activate) a relevant low-level policy and additionally perform focus adjustment.

The feedback learner 24 may provide the compensation function (Q-value) to the focus controller 22, based on the positive or negative feedback, and the focus controller 22 may maximize the provided compensation function (Q-value) to learn a policy.

When the feedback learner 24 recognizes the comfort of the user or that additional focus adjustment is not needed, through positive feedback recognition, the feedback learner 24 may provide a positive compensation function (Q-value) to the focus controller 22. However, when the feedback learner 24 recognizes the discomfort of the user or that additional focus adjustment is needed, through negative feedback recognition, the feedback learner 24 may provide a negative compensation function (Q-value) to the focus controller 22. As described above, the feedback learner 24 may evaluate a result of focus adjustment and may continuously improve the compensation function (Q-value), thereby enabling continuous learning and personalization. Each low-level policy may maintain a Q-value on various state(s)-action (a) pairs. For example, in the sharpness adjustment policy, a Q-value on a state(s)-action (a) pair of “reading(s)-sharpness (a) in dark illumination”. That is, when a satisfaction of the user is recognized after focus adjustment, R may be positive compensation, and a Q-value on an increase in sharpness may be updated. A Q-value Q(s,a) may be updated as expressed in the following Equation 1.

$$Q ( s , a ) ← Q ( s , a ) + α ( R + γ max Q ( {s}^{′} , {a}^{′} ) - Q ( s , a ) ) \qquad [ Equation 1 ]$$

Here, s may denote a current state (for example, reading, driving, environment, etc.), and a may denote a current action (for example, a focus adjustment operation).

Q(s, a) may denote a Q-value when a focus adjustment operation (a) is performed in a current state(s).

R may denote compensation which may be provided immediately when focus adjustment is performed in the current state(s).

Also, maxQ(s′, a′) may denote a Q-value which is the largest in the middle of a focus adjustment operation (a′) capable of being selected in a next state (s′).

Also, α may denote a learning rate (0≤α≤1), and α may be a parameter for adjusting the degree to which new information (estimation values of current compensation and future compensation) is reflected in the Q-value in reinforcement learning

Also, γ may denote a discount factor, and γ may be a parameter for adjusting an importance of future compensation.

As a Q-value is updated, personalization of focus adjustment may be continuously improved through an update, and thus, the need for repeated feedback may be reduced, and an accuracy of focus may be enhanced.

The feedback learner 24 may be implemented as an algorithm which calculates “positive compensation” or “negative compensation” through reinforcement learning, based on after-focus-adjustment explicit and implicit feedback. A focus adjustment algorithm of the focus controller 22 may be continuously improved for maximizing “positive compensation” (optimal user experience) over time.

When a preference of the user is changed based on a new condition (for example, a change in an action) through a dynamic feedback weight, the feedback learner 24 may add many weights to recent feedback to continuously respond to a change in a request without depending on only past data. That is, the feedback learner 24 may continuously learn after-focus-adjustment user feedback through reinforcement learning to update a Q-value.

The feedback learner 24 may update the focus controller 22 through positive compensation on positive feedback, and negative feedback (for example, “utter more clearly”, and “unfocused”) may update the focus controller 22 to adjust policy determination on negative compensation. A policy may be adjusted based on such a feedback loop, and thus, pattern learning on a user focus preference may be enhanced.

Reinforcement learning (for example, DQN) may generate a continuous learning period, and thus, may predict a preference of the user and may optimize a focus even without an input of explicit feedback in all situations. Also, the feedback learner 24 may learn a method which dynamically adapts to various situations and adapts based on an environment and an action of the user. The smooth adjustment of a focus may be performed over time so that a focus is personalized based on feedback of the user, and a reaction with the user is progressively reduced. For example, when positive compensation (Q-value) is continuously provided to the focus controller 22 in association with a focus adjustment request for reading, the feedback learner 24 may preferentially process an operation of improving a short-distance focus in a reading scenario later. On the other hand, when the feedback learner 24 continuously provides negative compensation (for example, compensation based on sensing of the discomfort of eyes or a readjustment voice command) to the focus controller 22 in an arbitrary operation, the focus controller 22 may operate to avoid corresponding focus adjustment. The HRL model 20 may predict a focus of the user through continuous learning, thereby providing a personalized focus experience improved whenever used.

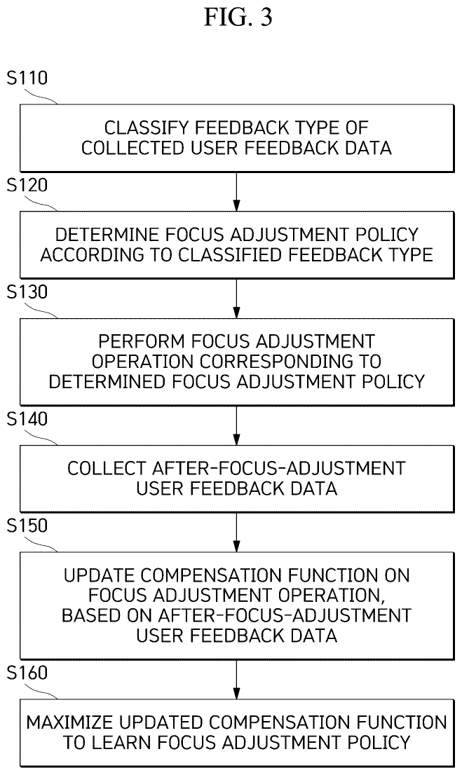

FIG. 3 is a flowchart for describing a method of controlling focus-adjustable glasses based on user feedback according to an embodiment of the present disclosure.

Referring to FIG. 3, first, in step S110, the feedback classifier 10 may classify a feedback type of user feedback data collected from the focus-adjustable glasses 10. In an embodiment, the user feedback data may include explicit feedback data including a voice command and implicit feedback data including an eye motion pattern. In an embodiment, the feedback type may include sharpness adjustment, focus adjustment for environment adaptation, short-distance focus adjustment, and long-distance focus adjustment.

Subsequently, in step S120, the focus controller 22 may determine a focus adjustment policy, based on the classified feedback type. In an embodiment, the focus controller 22 may determine the focus adjustment policy through hierarchical reinforcement learning. In an embodiment, the focus adjustment policy may include a high-level policy for determining a prior processing target of the feedback type and a low-level policy for determining the focus adjustment operation on a feedback type determined to be the prior processing target.

Subsequently, in step S130, the focus controller 22 may perform a focus adjustment operation corresponding to the determined focus adjustment policy.

Subsequently, in step S140, the feedback learner 24 may collect after-focus-adjustment user feedback data from the focus-adjustable glasses 100 adjusted based on the focus adjustment operation.

Subsequently, in step S150, the feedback learner 24 may update a compensation function on the focus adjustment operation, based on the after-focus-adjustment user feedback data. In an embodiment, the feedback learner 24 may update the compensation function by using a reinforcement learning algorithm (for example, DQN). In an embodiment, the compensation function may be a compensation value (Q-value) on a current state(s) representing a peripheral environment (for example, illumination, etc.) and an action (for example, driving, reading, etc.) of the user and a focus adjustment operation (a) which has been performed in the current state.

Subsequently, in step S160, the focus controller 22 may maximize an updated compensation function to learn the focus adjustment policy.

Implementations of various technologies described herein may be implemented with a digital electronic circuitry, computer hardware, firmware, software, or a combination thereof. The implementations may be implemented as a computer program product (i.e., an information carrier (for example, a machine-readable storage device (computer-readable media or a computer program typically embodied in a propagation signal), for processing by an operation of a data processing device (for example, a programmable processor, a computer, or a plurality of computers) or controlling the operation. A computer program such as the computer program(s) described above may be recorded in a programming language of an arbitrary type including compiled or interpreted languages and may be an independent program, or may be provided as an arbitrary type including a module, a component, a subroutine, or another unit appropriate for use in a computing environment. The computer program may be provided to be processed in one computer or a plurality of computers in one site or to be distributed all over a plurality of sites and connected to each other by a communication network.

Processors appropriate for processing of a computer program may include, for example, all of general-use and special-purpose microprocessors and one or more arbitrary processors of an arbitrary kind of digital computer. Generally, a processor may receive instructions and data from read only memory or random access memory or both thereof. Elements of a computer may include at least one processor executing instructions and one or more memory devices storing the instructions and the data. Generally, a computer may include one or more large-scale storage devices (for example, magnetic disks, magneto-optical disks, or optical disks) storing data, or may be coupled to receive data therefrom or transfer data thereto or transfer and receive data to and from both thereof. Information carriers appropriate for embodying computer program instructions and data may include, for example, semiconductor memory devices (for example, a hard disk, magnetic media such as a floppy disk and a magnetic tape, compact disk read only memory (CD-ROM), optical media such as a digital video disk (DVD), magneto-optical media such as a floptical disk, read only memory (ROM), random access memory (RAM), flash memory, erasable programmable ROM (EPROM), and electrically erasable programmable ROM (EEPROM)). A processor and a memory may be complemented by a special-purpose logic circuitry, or may be included therein.

The present disclosure may provide technology which may analyze user focus requirements, based on explicit and implicit feedback, and thus, may perform immediate focus adjustment and may determine a user focus pattern through continuous learning to provide a person-customized focus. Accordingly, the present disclosure may adjust a focus in real time through an interaction with a user, and moreover, unlike conventional technology, may learn user feedback to continuously provide an optimized focus, in addition to simply reflecting feedback.

Moreover, the present disclosure may learn a user preference pattern over time, and thus, may predict a preference of the user and may provide an optimized focus even without a personal feedback input in all situations. Accordingly, a personal request of the user for focus adjustment may decrease, and the user may be provided with an optimal focus to be adaptive for an environment condition and a personal state in various situations such as reading, driving, and computer manipulation.

As a result, the present disclosure may maximize a user experience and may enable personalized focus adjustment, thereby providing an optimal focus environment and the convenience of a user enhanced compared to conventional technology.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling focus-adjustable glasses based on user feedback, the method comprising:
a step of classifying a feedback type of user feedback data collected from focus-adjustable glasses by using a feedback classifier;
a step of determining a focus adjustment policy according to the classified feedback type and performing a focus adjustment operation corresponding to the determined focus adjustment policy by using a focus controller;
a step of collecting after-focus-adjustment user feedback data from the focus-adjustable glasses adjusted based on the focus adjustment operation and updating a compensation function on the focus adjustment operation by using a feedback learner, based on the after-focus-adjustment user feedback data; and
a step of maximizing the updated compensation function to learn the focus adjustment policy by using the focus controller.

2. The method of claim 1, wherein the user feedback data comprises explicit feedback data including a voice command and implicit feedback data including an eye motion pattern.

3. The method of claim 1, wherein the feedback type comprises sharpness adjustment, focus adjustment for environment adaptation, short-distance focus adjustment, and long-distance focus adjustment.

4. The method of claim 1, wherein the step of performing the focus adjustment operation comprises a step of determining the focus adjustment policy through hierarchical reinforcement learning.

5. The method of claim 1, wherein the focus adjustment policy comprises a high-level policy for determining a prior processing target of the feedback type and a low-level policy for determining the focus adjustment operation on a feedback type determined to be the prior processing target.

6. The method of claim 1, wherein the step of updating the compensation function comprises a step of updating the compensation function by using a reinforcement learning algorithm.

7. The method of claim 6, wherein the compensation function is a compensation value on a current state(s) representing a peripheral environment and an action of a user and a focus adjustment operation (a) which has been performed in the current state.

8. A control apparatus for controlling focus-adjustable glasses based on user feedback, the control apparatus comprising:
a communication device configured to receive user feedback data from focus-adjustable glasses; and
a processor configured to learn the user feedback data to execute a software module performing focus adjustment of the focus-adjustable glasses,
wherein the software module comprises:
a feedback classifier configured to classify a feedback type of user feedback data collected from the focus-adjustable glasses;
a focus controller configured to determine a focus adjustment policy according to the classified feedback type and perform a focus adjustment operation corresponding to the determined focus adjustment policy; and
a feedback learner configured to collect after-focus-adjustment user feedback data from the focus-adjustable glasses adjusted based on the focus adjustment operation and update a compensation function on the focus adjustment operation, based on the after-focus-adjustment user feedback data.

9. The control apparatus of claim 8, wherein the focus controller maximizes the updated compensation function to learn the focus adjustment policy.

10. The control apparatus of claim 8, wherein the user feedback data comprises explicit feedback data including a voice command of the user and implicit feedback data including an eye motion pattern of the user.

11. The control apparatus of claim 8, wherein the feedback type comprises sharpness adjustment, focus adjustment for environment adaptation, short-distance focus adjustment, and long-distance focus adjustment.

12. The control apparatus of claim 8, wherein the focus adjustment policy comprises a high-level policy for determining a prior processing target of the feedback type and a low-level policy for determining the focus adjustment operation on a feedback type determined to be the prior processing target.

13. The control apparatus of claim 8, wherein the feedback learner updates the compensation function by using a reinforcement learning algorithm.

14. The control apparatus of claim 13, wherein the compensation function is a compensation value on a current state(s) representing a peripheral environment and an action of a user and a focus adjustment operation (a) which has been performed in the current state.

15. The control apparatus of claim 8, wherein each of the focus controller and the feedback learner is implemented as a hierarchical reinforcement learning model.
